(19) United States
(12) Patent Application Publication
(10) Pub. No.: US 2010/0132548 A1
(43) Pub. Date: Jun. 3, 2010

(54) TEMPERATURE CONTROLLED ADSORPTION FOR DEHYDRATION OF WATER RICH STREAMS

(76) Inventors: Stephen R. Dunne, Algonquin, IL (US); David A. Wegerer, Lisle, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/337,248

(22) Filed: Dec. 17, 2008

(51) Int. Cl. B01D 53/02

(52) U.S. Cl. 95/120; 95/117

(57) ABSTRACT

A process for dehydration of a water rich stream, the process comprising providing a process stream to a first temperature controlled adsorber that is undergoing adsorption, where the first temperature controlled adsorber has one or more adsorption flow passages containing an adsorptive material coating and one or more heat transfer flow passages and producing a dehydrated effluent stream. The process stream is passed through the one or more adsorption flow passages, where water is adsorbed by the adsorptive material coating, and a heat of adsorption is generated. The heat of adsorption is removed by passing a cooling fluid through the one or more heat transfer flow passages. The process stream can be a process stream for producing motor fuel grade ethanol.

### FIELD OF THE INVENTION

The systems and processes disclosed herein relate generally to temperature controlled adsorption for use in dehydrating water rich streams. One particular example relates to the dehydration of fermientation beer for use in producing motor fuel grade ethanol.

### DESCRIPTION OF RELATED ART

Adiabatic adsorption is a process that is employed for bulk water removal, within certain water concentration limits, and purification applications. For example, adiabatic adsorption via molecular sieves is a widely practiced method for removing water from process streams.

The adsorption and desorption reactions that occur during adiabatic adsorption are considered adiabatic since the adsorber and process fluid being treated constitute a system that does not exchange beat with any other adjacent stream within the adsorbent containing contactor. The dynamic nature of the adiabatic water adsorption process, specifically, temperatures rising during adsorption and falling during regeneration, necessarily reduces the adsorbent absolute and differential loading potentials, the latter due to less than perfect regeneration. Additionally, adiabatic operation of an adsorber results in a thermal front preceding the adsorption front. As a consequence, achievable product purities are lowered. For bulk water removal applications, this imposes an upper limit on the water concentration of the process fluid to be treated. The upper limit on water concentration results because in adiabatic adsorption systems, which do not have heat removal capability, the heat liberation associated with a high water content stream feeding an adiabatic adsorber can drive the product end of the bed to a sufficiently high temperature to reduce, or even eliminate, the driving force for adsorption.

As a result, processes for removing water from a mixture containing water and an organic compound to be dehydrated, such as, for example, ethanol, commonly involve process steps to remove water from the mixture prior to the mixture undergoing adsorption.

For example, motor fuel grade ethanol (MFGE) consumer product specifications typically limit water concentrations to less than 1% by volume, and in many countries less than 0.5% by volume. Fuel ethanol (E-95) quality for use in the USA is governed by the specifications listed in ASTM D 4806, entitled “Standard Specification for Denatured Fuel Ethanol for Blending with Gasoline's for use as an Automotive Spark-Ignition Engine Fuel.” The ASTM specification is a water content of 1% by volume. Because ethanol is hygroscopic and easily picks up water from ambient air and the distribution system, the MFGE process specification for water content of the MFGE product is typically tighter than the ASTM specification, and, in at least some instances, can require a maximum water content of about 0.5% by weight. It should be noted that a product stream having about 99% by volume ethanol and about 1% by volume water has about 98.75% by weight ethanol and 1.25% by weight water.

Industrial processes for producing motor fuel grade ethanol (MFGE) include fermentation of starches and lignocellulose. The effluent from the fermentation process, commonly known as fermentation beer, is a water-rich mixture containing water, alcohols, soluble solids, and insoluble solids. The alcohol content of fermentation beer is primarily ethanol. Beer from fermentation typically has a very high water content, which can be in the range of about 70% by weight to about 90% percent by weight of the fermentation beer. The ethanol content of fermentation beer is dependent on the sugar source. For example, fermentation beer for producing ethanol from corn starch can typically have an ethanol content in the range of about 5% to about 15% by weight, such as an ethanol content of about 10% by weight of the fermentation beer. Generally, the ethanol content of fermentation beer is in the range of from about 3% by weight to about 20% by weight. Accordingly, concentrating and purifying the ethanol contained in fermentation beer too achieve an MFGE product that meets specifications entails removing the relatively large amount of water.

Separating ethanol from beer is usually accomplished through distillation up to the ethanol-water azeotropic mixture concentration, which is about 95% by weight ethanol, and subsequent drying via other means in order to meet the MFGE water specification. The distillation sequence generally involves separating solids and some water from the effluent stream of a fermentation process, such as through the use of a beer column or other suitable solids separation unit. The process stream from a solids separation unit, containing nominally from about 55% by weight to about 70% by weight ethanol is sent to a second distillation tower, also known as a Rectifier column, to obtain an ethanol-water overhead product near the ethanol-water azeotropic mixture concentration.

Dehydration of the ethanol-water overhead product can then be accomplished via pressure swing molecular sieve adsorption (PSA), or via other processes such as extractive distillation. The pressure swing molecular sieve adsorption (PSA) technology commonly used to dehydrate the ethanol-water overhead product is an adiabatic process, which is the reason that distillation is normally used to minimize the water in the ethanol-water mixture that feeds the PSA unit.

### SUMMARY OF THE INVENTION

Systems and processes disclosed herein relate generally to temperature controlled adsorption for use in dehydrating water rich streams. One particular example relates to the dehydration of fermentation beer for use in producing motor fuel grade ethanol (MFGE).

In one aspect, a process for dehydration of a water rich stream is provided that includes providing a process stream to a first temperature controlled adsorber that is undergoing adsorption, where the first temperature controlled adsorber has one or more adsorption flow passages containing an adsorptive material coating and one or more heat transfer flow passages and producing a dehydrated effluent stream. The process stream is passed through the one or more adsorption flow passages, where water is adsorbed by the adsorptive material coating, and a heat of adsorption is generated. The heat of adsorption is removed by passing a cooling fluid through the one or more heat transfer flow passages. The process can further include providing a second temperature controlled adsorber undergoing regeneration that is isolated from the process stream, where the second temperature controlled adsorber has one or more adsorption flow passages containing an adsorptive material coating and one or more heat transfer flow passages, and producing a cooled heating fluid and an effluent stream that is water rich. The heating fluid is provided to the one or more heat transfer flow passages of the second temperature controlled adsorber, and the adsorptive material coating is regenerated by removing water.

In another aspect, a process for production of motor fuel grade ethanol is provided that includes providing a process stream to a first temperature controlled adsorber that is undergoing adsorption, where the first temperature controlled adsorber has one or more adsorption flow passages containing an adsorptive material coating and one or more heat transfer flow passages, and producing an MFGE product stream containing less than 5% by weight water. The process includes passing the process stream through the one or more adsorption flow passages, where water is adsorbed by the adsorptive material coating, generating heat of adsorption, and removing heat of adsorption by passing a cooling fluid through the one or more heat transfer flow passages. The process can further include providing a second temperature controlled adsorber undergoing regeneration that is isolated from the process stream, where the second temperature controlled adsorber has one or more adsorption flow passages containing an adsorptive material coating and one or more heat transfer flow passages, and producing a cooled heating fluid and a water effluent stream. The heating fluid is provided to the one or more heat transfer flow passages of the second temperature controlled adsorber, and the adsorptive material coating is regenerated by removing water.

As used herein, the terms “stream” and “fluid” should be understood as encompassing either liquid or vapor, or both, as suitable based upon the temperature and pressure of the stream or fluid as suitable for the intended application.

### BRIEF DESCRIPTION OF THE DRAWINGS

Specific examples have been chosen for purposes of illustration and description, and are shown in the accompanying drawings, forming a part of the specification.

FIG. 1 illustrates a simplified process flow diagram for an adsorption process including temperature controlled adsorbers.

FIG. 2a is a perspective view of a temperature controlled adsorber that can be used in the process of FIG. 1.

FIG. 2b is a close-up view of a portion of FIG. 2a.

FIG. 2c is a close-up view of another portion of FIG. 2a.

FIG. 3 is a perspective view of a portion of a temperature controlled adsorber of FIG. 2a.

FIG. 4 is a rotated view of FIG. 3.

FIG. 5 illustrates a simplified process flow diagram for a processes for producing MFGE utilizing temperature controlled adsorbers.

### DETAILED DESCRIPTION

The systems and processes disclosed herein relate generally to temperature controlled adsorption for use in dehydrating water rich streams.

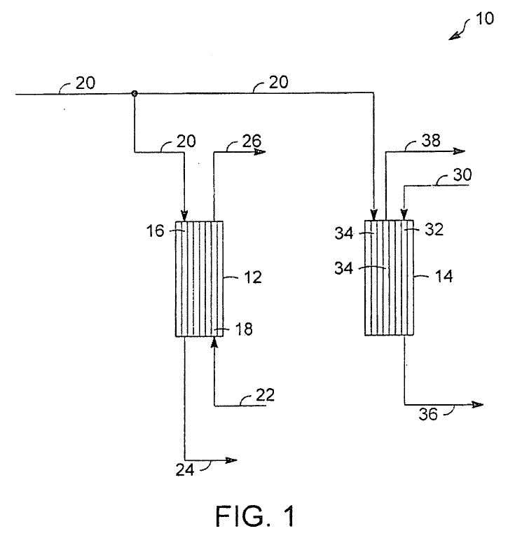

FIG. 1 illustrates a process for dehydration of a water rich stream, the process being indicated generally at 10. As shown in FIG. 1, the dehydration process 10 includes a first temperature controlled adsorber 12, and a second temperature controlled adsorber 14. Temperature controlled adsorbers 12 and 14 are preferably adsorbent containing contactors having internal indirect heat transfer passages.

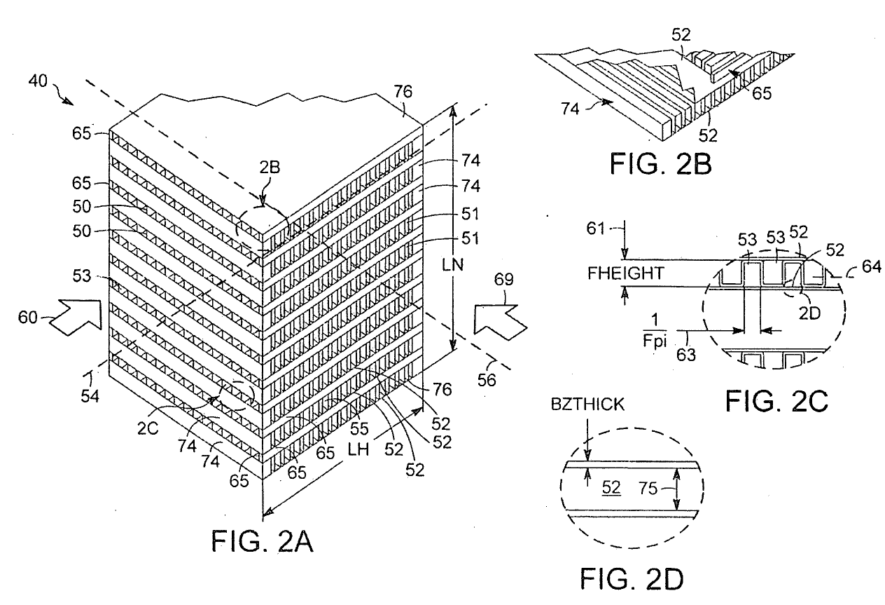

FIGS. 2a through 2d illustrate one example of a temperature controlled adsorber 40, which can be utilized in the process of FIG. 1 as either first temperature controlled adsorber 12, second temperature controlled adsorber 14, or preferably both. Temperature controlled adsorber 40 is a plate-fin type heat exchanger with one or more adsorption flow passages 53 and one or more heat transfer flow passages 55. The adsorption flow passages 53 contain an adsorptive material coating 46 that is applied by a wash-coating process. During the wash-coating process, the adsorption flow passages 53 are wash coated with a wash-coating fluid that contains an adsorbent material suitable for water adsorption including molecular sieves Type A and X, NaY, silica gel, alumina, and MOLSIV DDZ-70, which is produced by UOP. The wash-coating fluid also contains an organic polymer system and an organic solvent or carrier fluid. In one example, a adsorptive material coating 46 can contain a polymer and a zeolite, such as, for example, a Type 4A or a Type 3A zeolite.

A wash-coating process can comprise a step of heating a component to be coated, a step of contacting the surface of the component with a slurry comprising an adsorbent and a binder to form an adsorptive material coating 46, and a step of hardening the adsorptive material coating 46. For some applications, the step of contacting may comprise dipping the surface into the slurry or spraying the surface with the slurry.

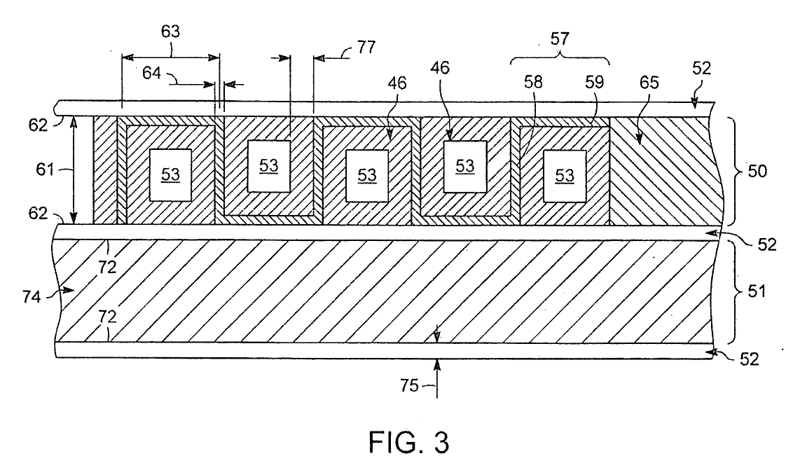

The adsorptive material coating 46 may have an adsorptive coating thickness 77 (see FIG. 3) of between about 0.004 inches (0.010 cm) and about 0.052 inches (0.13 cm), preferably from about 0.014 inches (0.035 cm) to about 0.023 inches (0.058 cm). The adsorptive coating thickness 77 may be measured through the adsorptive material coating 46 and about perpendicular to the adsorption zone fin 58. The adsorptive coating thickness 77 may vary with application and may depend on factors including the dimensions of the adsorption zone fins 58, the desired dimensions of the adsorption flow passage 55 and the application. Co-pending U.S. patent application Ser. No. 11/461,271, entitled “Adsorption Heat Exchanger,” the disclosure of which is hereby incorporated by reference in its entirety, describes the rudiments of the wash-coating process and some of the benefits that ensue in sorption cooling systems.

As illustrated in FIGS. 2a-2d, adsorption heat exchanger 40 can comprise at least one adsorption layer 50, at least one heat transfer layer 51 and a separator plate 52 positioned between and in contact with the adsorption layer 50 and the heat transfer layer 51. The adsorption heat exchanger 40 can comprise a plurality of adsorption layers 50 and a plurality of heat transfer layers 51. The adsorption layers 50 and heat transfer layers 51 may be positioned in a stacked arrangement of alternating adsorption layers 50 and heat transfer layers 51. In other words, one adsorption layer 50 may be positioned between two heat transfer layers 51; and one heat transfer layer 51 may be positioned between two adsorption layers 50. The adsorption heat exchanger 40 can comprise a plurality of separator plates 52 positioned such that one separator plate 52 is between and in contact with each adsorption layer/heat transfer layer pair. In other words, the separator plate 52 may be positioned between the adsorption layer 50 and the heat transfer layer 51. As defined herein, an adsorption layer/heat transfer layer pair may comprise an adsorption layer 50 and a heat transfer layer 51 positioned adjacent to one another.

The adsorption layer 50 may provide an adsorption flow passage 53 through the adsorption heat exchanger 40. The adsorption flow passage 53 may be in a direction parallel to an adsorption flow line 54. The heat transfer layer 51 may define a heat transfer flow passage 55 through the adsorption heat exchanger 40. The heat transfer flow passage 55 may be in a direction parallel to a heat transfer flow line 56. The adsorption flow line 54 may be about 90° from the heat transfer flow line 56. This type of system provides cross flow heat exchange. In alternative examples, an adsorption heat exchanger can operate with either parallel or counter flow heat transfer.

As depicted in FIG. 3, the adsorption layer 50 can include an adsorption zone corrugated sheet 57 and the adsorptive material coating 46. The adsorption zone corrugated sheet 57 may be in contact with and extend between two separator plates 52. The adsorption zone corrugated sheet 57 may comprise a plurality of adsorption zone fins 58 and a plurality of adsorption zone contact portions 59. The adsorption zone fin 58 may be the portion of the adsorption zone corrugated sheet 57 that is perpendicular to and extends between the separator plates 52. The adsorption zone contact portion 59 may be the portion of the adsorption zone corrugated sheet 57 that is parallel to and in contact with the separator plate 52.

The adsorption zone fins 58 may be positioned about perpendicular to the separator plates 52 and may extend about parallel to the adsorption flow line 54. The adsorption zone fins 58 may direct the flow of an adsorbate rich stream 60, as shown in FIG. 2a, through the adsorption heat exchanger 40 and may provide a support for at least a portion of the adsorptive material coating 46. The adsorption zone fin 58 may be in contact with and extend between two separator plates 52. The adsorption fin height 61 may vary with application and may depend on factors including the composition of the adsorption zone fin 58 and the application. The adsorption fin thickness 64 may vary with application and may depend on factors including the composition of the adsorptive material coating 46 and the application. The density of adsorption zone fins (fins/inch) may vary with application and may depend on factors including the thickness of the adsorptive material coating 46 and the desired volume of the adsorption flow passage 53. The density of the adsorption zone fins 58 may be defined as the number of fins per inch of adsorption layer width as measured perpendicular to the adsorption flow line 54 and parallel to the separator plate 52.

The adsorption zone contact portions 59 may be positioned about parallel to and in contact with the separator plates 52. The adsorption zone contact portions 59 may be brazed to an adsorption zone facing side 62 of the separator plates 52. The adsorption zone contact portions 59 may provide a support for at least a portion of the adsorptive material coating 46, as depicted in FIG. 3. In other words, one side of the adsorption zone contact portion 59 may be brazed to the separator plate 52 and the other side may be coated with the adsorptive material coating 46. The adsorption contact width 63 is not an independent parameter. Once the density of the adsorption zone fins 58 and the adsorption fin thickness 64 have been specified the adsorption contact width 63 is a determinate value. The adsorption contact portion width 63 may vary and may depend on the desired density of the adsorption zone fins 58. The adsorption contact portion width 63 may be inversely proportion to the density of the adsorption zone fins 58.

For some applications, in lieu of the adsorption zone corrugated sheet 57, the adsorption layer 50 may comprise a plurality of adsorption zone fins 58 brazed directly to the separator plates 52. The adsorption zone fins 58 of the adsorption layer 50 may increase the surface area available for adsorptive material coating 46, thereby enhancing the adsorption/desorption efficiency of the adsorption heat exchanger 40.

The adsorption layer 50 may include two adsorption zone header bars 65, as depicted in FIG. 2a. The adsorption zone header bars 65 may be positioned parallel to the adsorption flow line 54. One adsorption zone header bar 65 may be positioned at one side of the adsorption layer 50 and the other adsorption zone header bar 65 may be positioned at the opposing side of the adsorption layer 50. The adsorption zone header bars 65 may be brazed to the separator plates 52 and may provide structural support to the adsorption heat exchanger 40.

The adsorption zone corrugated sheet 57, the adsorption zone fin 58, the adsorption zone contact portion 59 and adsorption zone header bar 65 each may comprise a material, such as but not limited to, aluminized Mylar®, a polymer composite, or a metal. Mylar® is a polyester film produced by E.I. Du Pont De Nemours and Company. Useful metals may include aluminum, copper, titanium, brass, stainless steel, other light metals and alloys with high conductivity, and graphite fiber composite materials. Components of the adsorption layer 50 may provide support for the adsorptive material coating 46.

The adsorptive material coating 46 of the adsorption layer 50 may define the adsorption flow passage 53, as depicted in FIG. 3. For some embodiments of the present invention, the adsorptive material coating 46 may define at least a portion of the adsorption flow passage 53. The adsorptive material coating 46 may be positioned on and in contact with the adsorption zone fins 58. Additionally, the adsorptive material coating 46 may be positioned on and in contact with the adsorption zone contact portions 59. Further, the adsorptive material coating 46 may be positioned on and in contact with at least a portion of the adsorption zone facing side 62 of the separator plates 52, as depicted in FIG. 3.

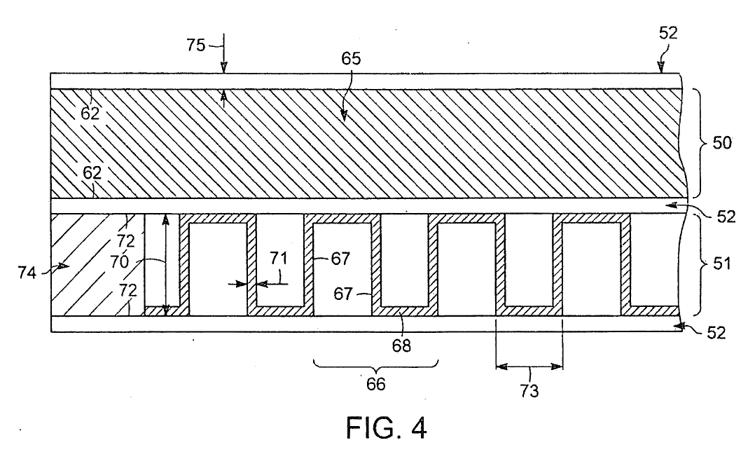

The heat transfer layer 51 may include a heat transfer zone corrugated sheet 66, as depicted in FIG. 4. The heat transfer zone corrugated sheet 66 may be in contact with and extend between two separator plates 52. The heat transfer zone corrugated sheet 66 may comprise a plurality of heat transfer zone fins 67 and a plurality of heat transfer zone contact portions 68. The heat transfer zone fin 67 may be the portion of the heat transfer zone corrugated sheet 66 that is perpendicular to and extends between the separator plates 52. The heat transfer zone contact portion 68 may be the portion of the heat transfer corrugated sheet 66 that is parallel to and in contact with the separator plate 52.

The heat transfer zone fins 67 may be positioned about perpendicular to the separator plates 52 and may extend about parallel to the heat transfer flow line 56. The heat transfer zone fins 67 may direct the flow of heat transfer fluid 69, as shown in FIG. 2a, through the adsorption heat exchanger 40. The heat transfer zone fins 67 may increase the heat transfer efficiency of the adsorption heat exchanger 40. The heat transfer zone fin 67 may be in contact with and extend between two separator plates 52. The heat transfer fin height 70 may vary with application and may depend on factors including the composition of the heat transfer zone fin 67 and the application. The heat transfer fin thickness 71 may vary with application and may depend on factors including the composition of the heat transfer fluid 69 and the application. The density of heat transfer zone fins (fins/inch) may vary with application and may depend on factors including the composition of the heat transfer fluid 69 and the desired volume of the heat transfer flow passage 55. The density of the heat transfer zone fins 67 may be defined as the number of fins per inch of the heat transfer layer width as measured perpendicular to the heat transfer flow line 56 and parallel to the separator plate 52.

The heat transfer zone contact portions 68 may be positioned about parallel to and in contact with the separator plates 52. The heat transfer zone contact portions 68 may be brazed to a heat transfer zone facing side 72 of the separator plates 52. The heat transfer contact portion width 73 may vary and may depend on the desired density of the heat transfer zone fins 67. The heat transfer contact portion width 73 may be inversely proportion to the density of the heat transfer zone fins 67.

For some applications, in lieu of the heat transfer zone corrugated sheet 66, the heat transfer layer 51 may comprise a plurality of heat transfer zone fins 67 brazed directly to the separator plates 52.

The heat transfer layer 51 may include two heat transfer zone header bars 74, as depicted in FIG. 2a. The heat transfer zone header bars 74 may be positioned parallel to the heat transfer flow line 56. One heat transfer zone header bar 74 may be positioned at one side of the heat transfer layer 51 and the other heat transfer zone header bar 74 may be positioned at the opposing side of the heat transfer layer 51. The heat transfer zone header bars 74 may be brazed to the separator plates 52 and may provide structural support to the adsorption heat exchanger 40.

The heat transfer zone corrugated sheet 66, the heat transfer zone fin 67, the heat transfer zone contact portion 68 and heat transfer zone header bar 74 each may comprise any suitable material, such as but not limited to, aluminized Mylar®, a polymer composite, or a metal. Useful metals may include aluminum, copper, titanium, brass, stainless steel, other light metals and alloys with high conductivity, and graphite fiber composite materials.

The separator plate 52 of the adsorption heat exchanger 40 may comprise a sheet material structure, as depicted in FIGS. 2a-c. The separator plate 52 may be positioned parallel to the layers 50, 51, as shown in FIGS. 3 and 4. One separator plate 52 may be positioned between and in contact with each adsorption layer/heat transfer layer pair. The separator plate 52 may prevent the flow of adsorbate 60 from entering the heat transfer layer 51 and prevent the flow of heat transfer fluid 69 from entering the adsorption layer 50. The separator plate 52 may comprise any suitable material, such as but not limited to, aluminized Mylar®, a polymer composite, or a metal. Useful metals may include aluminum, copper, titanium, brass, stainless steel, other light metals and alloys with high conductivity, and graphite fiber composite materials. The width and length of the separator plate 52 may vary and may be about equal to the width and length of the layers 50, 51.

The adsorption heat exchanger 40 further may comprise two side plates 76, as depicted in FIG. 2a. The side plates 76 may be positioned parallel to the layers 50, 51. One side plate 76 may be positioned at one side of the adsorption heat exchanger 40 and the other side plate 76 may be positioned at the opposing side of the adsorption heat exchanger 40. The side plates 76 may comprise any suitable material, such as but not limited to, aluminized Mylar®, a polymer composite, or a metal. For some applications, the side plates 76 may be brazed to and provide structural support for the adsorption heat exchanger 40.

Referring back to FIG. 1, a process stream 20 can be directed to either the first temperature controlled adsorber 12 or the second temperature controlled adsorber 14. For illustrative purposes, temperature controlled adsorber 12 will be described as undergoing adsorption, while temperature controlled adsorber 14 will be described as undergoing regeneration. It should be understood that during operation, the temperature controlled adsorbers 12 and 14 are preferably each cycled through alternating adsorption and regeneration steps. Accordingly, when first temperature controlled adsorber 12 is undergoing adsorption, second temperature controlled adsorber 14 is preferably undergoing regeneration. Similarly, when second temperature controlled adsorber 14 is undergoing adsorption, first temperature controlled adsorber 12 is preferably undergoing regeneration. It should also be understood that each temperature controlled adsorber has sufficient connections and feeds to function appropriately when undergoing either adsorption or regeneration, although only a portion of the actual connections to each temperature controlled adsorber are illustrated in FIG. 1.

When first temperature controlled adsorber 12 is undergoing adsorption, process stream 20 is provided to one or more inlets of first temperature controlled adsorber 12. The process stream 20 can be a vapor stream derived from a reaction process effluent stream. The process stream 20 can also be a water rich stream, and can contain water in an amount of up to about 85% by weight or greater. Process stream 20 flows through the one or more adsorption flow passages 16 of the first temperature controlled adsorber 12. Water is adsorbed by the adsorptive material coating in the one or more adsorption flow passages 16. In one example, the adsorptive material coating contains a polymer and a zeolite, such as, for example, a Type 4A or a Type 3A zeolite. The adsorption of the water generates heat, known as the heat of adsorption. The water adsorption process removes water from the process stream 20, and produces a dehydrated effluent stream 24. Dehydrated product stream 24 can have a significantly reduced weight percentage of water as compared to process stream 20. For example, dehydrated product stream 24 can be less than 5% water by weight, less than 2% water by weight, or less than 1% water by weight. In one example, dehydrated product stream 24 contains from about 0.25% water by weight to about 1.25% water by weight. Dehydrated product stream 24 exits the first temperature controlled adsorber 12, and can be utilized in its desired application.

The heat of adsorption of the water that is generated in first temperature controlled adsorber 12 is removed by indirect heat exchange with a cooling fluid 22. Cooling fluid 22 is provided to the one or more heat transfer flow passages 18 of the first temperature controlled adsorber 12, and exits the first temperature controlled adsorber 12 as heated cooling fluid 26.

When first temperature controlled adsorber 12 is undergoing adsorption, second temperature controlled adsorber 14 undergoes regeneration. During regeneration, second temperature controlled adsorber 14 is isolated from process stream 20. A heating fluid 30 is provided to, and passes through, the one or more heat transfer flow passages 32 of the second temperature controlled adsorber 14. The heating fluid 30 provides heat via indirect heat exchange to the one or more adsorption flow passages 34 of the second temperature controlled adsorber 14. The heat provided by heating fluid 30 is preferably sufficient to provide the regeneration heat requirement for the one or more adsorption flow passages 34. Additionally, the pressure in the one or more adsorption flow passages 34 may be reduced to facilitate regeneration. As heating fluid 30 passes through the one or more heat transfer flow passages 32, it loses heat and exits the second temperature controlled adsorber 14 as cooled heating fluid 36. Water that was adsorbed by the adsorptive material coating in the one or more adsorption flow passages 34 during the previous adsorption cycle of the second temperature controlled adsorber 14 is removed from the adsorptive material coating and exits the second temperature controlled adsorber 14 as a water effluent stream 38.

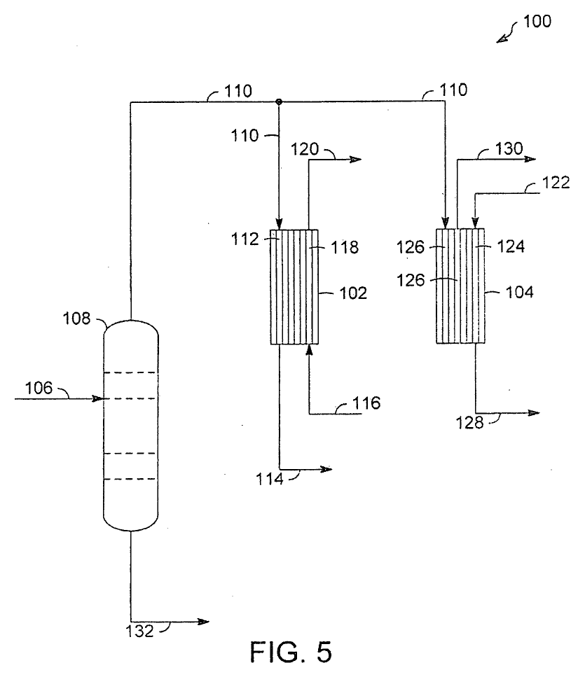

FIG. 5 illustrates a process for production of MFGE, the process being indicated generally at 100. As shown in FIG. 5, the MFGE production process 100 includes a first temperature controlled adsorber 102, and a second temperature controlled adsorber 104. Temperature controlled adsorbers 102 and 104 are preferably adsorbent containing contactors having internal indirect heat transfer passages, and can each be a temperature controlled adsorber of the type illustrated in FIGS. 2a-2d, 3 and 4.

In MFGE production process 100, beer stream 106, which is the effluent from fermentation of starches and lignocellulose, is provided to a solids separation unit 108, such as beer column. Beer stream 106 is be a water-rich mixture containing water, alcohols (primarily ethanol), soluble solids, and insoluble solids. Beer stream 106 can contain from about 70% by weight water to about 90% percent by weight water. Additionally, beer stream 106 can contain from about 3% by weight ethanol to about 20% by weight ethanol. Solids separation 108 produces a process stream 110 and bottoms stream 132. When solids separation unit 108 is a beer column, 99% by weight or greater of the ethanol in the fermentation beer stream 106 can typically be recovered in process stream 110 as a dilute ethanol and water mixture. Process stream 110 can contain from about 10% by weight water to about 85% by weight water. Process stream 110, or at least a portion of process stream 110, can be in a vapor phase. Bottoms stream 132 contains primarily water and solids.

Process stream 110 can be directed to either the first temperature controlled adsorber 102 or the second temperature controlled adsorber 104, depending upon which adsorber is undergoing an adsorption cycle. For illustrative purposes, temperature controlled adsorber 102 will be described as undergoing an adsorption cycle, while temperature controlled adsorber 104 will be described as undergoing a regeneration cycle. It should be understood that during operation, the temperature controlled adsorbers 102 and 104 are preferably each cycled through alternating adsorption and regeneration cycles. It should also be understood that each temperature controlled adsorber has sufficient connections and feeds to undergo either adsorption or regeneration, although only a portion of such connections and feeds are illustrated in FIG. 5.

When first temperature controlled adsorber 102 is undergoing adsorption, process stream 110 is provided to one or more inlets of first temperature controlled adsorber 102. Process stream 110 flows through the one or more adsorption flow passages 112 of the first temperature controlled adsorber 102. Water is adsorbed by an adsorptive material coating in the one or more adsorption flow passages 112. In one example, the adsorptive material coating contains a polymer and a zeolite, such as, for example, a Type 4A or a Type 3A zeolite. The adsorption of the water generates heat, known as the heat of adsorption. The water adsorption process removes water from the process stream 110, and produces a MFGE product stream 114. MFGE product stream 114 can be less than 5% water by weight, less than 2% water by weight, or less than 1% water by weight. Preferably, MFGE product stream 114 contains from about 0.25% water by weight to about 1.25% water by weight, and most preferably contains up to about 0.5% water by weight, or less than about 0.5% water by weight. MFGE product stream 114 preferably contains greater than 98% by weight ethanol. MFGE product stream 114 exits the first temperature controlled adsorber 102, and can be utilized in its desired application.

The heat of adsorption of the water that is generated in first temperature controlled adsorber 102 is removed by indirect heat exchange with a cooling fluid 116. Cooling fluid 116 is provided to the one or more heat transfer flow passages 118 of the first temperature controlled adsorber 102, and exits the first temperature controlled adsorber 102 as heated cooling fluid 120.

When first temperature controlled adsorber 102 is undergoing adsorption, second temperature controlled adsorber 104 undergoes regeneration. During regeneration, second temperature controlled adsorber 104 is isolated from process stream 110. A heating fluid 122 is provided to and passes through the one or more heat transfer flow passages 124 of the second temperature controlled adsorber 104. The heating fluid 122 provides heat via indirect heat exchange to the one or more adsorption flow passages 126 of the second temperature controlled adsorber 104. The heat provided by heating fluid 122 is preferably sufficient to provide the regeneration heat requirement for the one or more adsorption flow passages 126. Additionally, the pressure in the one or more adsorption flow passages 126 may be reduced to facilitate regeneration. As heating fluid 122 passes through the one or more heat transfer flow passages 124, it loses heat and exits the second temperature controlled adsorber 104 as cooled heating fluid 128. Water that was adsorbed by the adsorptive material coating in the one or more adsorption flow passages 126 during the previous adsorption cycle of the second temperature controlled adsorber 104 is removed from the adsorptive material coating, and exits the second temperature controlled adsorber 104 as water effluent stream 130.

Preferably, temperature controlled adsorption systems and processes can operate at conditions approaching isothermal conditions. In such examples, one or more benefits over operating an adiabatic adsorbent system or process can be achieved. For example, the upper limit on water concentration in the fluid to be treated can also be eliminated, providing the ability for dehydration of extremely water-rich streams. Additionally, increased differential loading potential can be provided, with substantially lower loadings achieved during regeneration and higher loadings achievable during adsorption steps. Lower product dew-points, lower product dew-point specifications for water in the product stream, and smaller equipment size for a given duty can be also achieved. Other benefits can include reduction of purge gas requirements during the regeneration step and simultaneous increase of the potential for recovering high concentrations of adsorbate (i.e. water) in the regeneration gas. Flexibility in selecting the heating and cooling heat transfer media with minimal impact on desired process streams can also be provided. Further, extremely rapid thermal swing adsorption with cycle times at or below current adiabatic PSA separation processes can be achieved, which can result in smaller adsorber systems, which saves both capital and energy.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A process for dehydration of a water rich stream, the process comprising:
providing a process stream to a first temperature controlled adsorber that is undergoing adsorption, where the first temperature controlled adsorber has one or more adsorption flow passages containing an adsorptive material coating and one or more heat transfer flow passages;
passing the process stream through the one or more adsorption flow passages, where water is adsorbed by the adsorptive material coating;
generating heat of adsorption;
removing heat of adsorption by passing a cooling fluid through the one or more heat transfer flow passages; and
producing a dehydrated effluent stream.

2. The process of claim 1, wherein the process stream contains water in an amount of up to about 85% by weight.

3. The process of claim 1, wherein the adsorptive material coating contains a polymer and a zeolite.

4. The process of claim 3, wherein the zeolite is a Type 4A or a Type 3A zeolite.

5. The process of claim 1, wherein the process stream includes ethanol and water.

6. The process of claim 1, wherein the dehydrated effluent stream contains less than 5% water by weight.

7. The process of claim 1, wherein the dehydrated effluent stream contains less than less than 2% water by weight.

8. The process of claim 1, wherein the dehydrated effluent stream contains from about 0.25% water by weight to about 1.25% water by weight.

9. The process of claim 1, wherein the process further comprises:
providing a second temperature controlled adsorber undergoing regeneration that is isolated from the process stream, where the second temperature controlled adsorber has one or more adsorption flow passages containing an adsorptive material coating and one or more heat transfer flow passages;
providing a heating fluid to the one or more heat transfer flow passages of the second temperature controlled adsorber;
regenerating the adsorptive material coating by removing water; and
producing a cooled heating fluid and a water effluent stream.

10. The process of claim 9, wherein at least one of the first temperature controlled adsorber or the second temperature controlled adsorber is a plate-fin type heat exchanger.

11. A process for dehydration of an effluent stream from a fermentation process for the production of motor fuel grade ethanol, the process comprising:
providing a process stream containing ethanol and water to a first temperature controlled adsorber that is undergoing adsorption, where the first temperature controlled adsorber has one or more adsorption flow passages containing an adsorptive material coating and one or more heat transfer flow passages;
passing the process stream through the one or more adsorption flow passages, where water is adsorbed by the adsorptive material coating;
generating heat of adsorption in the one or more adsorption flow passages;
removing heat of adsorption by passing a cooling fluid through the one or more heat transfer flow passages; and
producing an MFGE product stream containing less than 5% water by weight.

12. The process of claim 11, wherein the process stream contains from about 10% by weight water to about 85% by weight water.

13. The process of claim 11, wherein the adsorptive material coating contains a polymer and a zeolite.

14. The process of claim 13, wherein the zeolite is a Type 3A zeolite.

15. The process of claim 11, wherein the adsorptive material coating is applied by wash-coating the adsorption flow passages.

16. The process of claim 11, wherein the MFGE product stream contains from about 0.25% water by weight to about 1.25% water by weight.

17. The process of claim 11, wherein the MFGE product stream contains about 98.75% by weight ethanol.

18. The process of claim 11, wherein the process further comprises:
providing a second temperature controlled adsorber undergoing regeneration that is isolated from the process stream, where the second temperature controlled adsorber has one or more adsorption flow passages containing an adsorptive material coating and one or more heat transfer flow passages;
providing a heating fluid to the one or more heat transfer flow passages of the second temperature controlled adsorber;
regenerating the adsorptive material coating by removing water; and
producing a cooled beating fluid and a water effluent stream.

19. The process of claim 18, wherein at least one of the first temperature controlled adsorber or the second temperature controlled adsorber is a plate-fin type heat exchanger.

20. A process for dehydration of a water rich process stream, the process comprising:
providing a process stream to a first temperature controlled adsorber that is undergoing adsorption, where the first temperature controlled adsorber has one or more adsorption flow passages containing an adsorptive material coating and one or more heat transfer flow passages;
passing the process stream through the one or more adsorption flow passages, where water is adsorbed by the adsorptive material coating;
generating heat of adsorption;
removing heat of adsorption by passing a cooling fluid through the one or more heat transfer flow passages;
producing a dehydrated effluent stream;
providing a second temperature controlled adsorber undergoing regeneration that is isolated from the process stream, where the second temperature controlled adsorber has one or more adsorption flow passages containing an adsorptive material coating and one or more heat transfer flow passages;
providing a heating fluid to the one or more heat transfer flow passages of the second temperature controlled adsorber;
regenerating the adsorptive material coating by removing water; and
producing a cooled heating fluid and a water effluent stream.
